(19) United States
(12) Patent Application Publication
(10) Pub. No.: US 2013/0203483 A1
(43) Pub. Date: Aug. 8, 2013

(54) VIRTUAL CURRENCY BASED ONLINE SOCIAL WAGERING SYSTEM AND METHOD

(71) Applicants: Ashish Joshi, San Mateo, CA (US); Yogendra Ranade, Fremont, CA (US)

(72) Inventors: Ashish Joshi, San Mateo, CA (US); Yogendra Ranade, Fremont, CA (US)

(21) Appl. No.: 13/757,788

(22) Filed: Feb. 2, 2013

Related U.S. Application Data
(60) Provisional application No. 61/594,372, filed on Feb. 3, 2012.

(51) Int. Cl. G06F 17/00

(52) U.S. Cl. CPC G06F 17/00
USPC 463/25

(57) ABSTRACT

A virtual currency based online social wagering system and method, based on at least one wagering networks server. The system can handle wagers initiated by multiple users using commonly available computerized devices such as Smartphones. The system avoids legal problems through the use of virtual currency rather than money (which makes the interactions wager-like events, rather than actual wagers), and facilitates interactions between friends by drawing upon social networks for much of the interactions. The system is also designed to make friendly social interactions such as banter, “trash talk”, or “swagger” a key part of the wagering experience. Various internal controls insure that the virtual funds are managed correctly.

### CROSS REFERENCE TO RELATED APPLICATIONS

This application claims the priority benefit of U.S. provisional patent application 61/594,372, “VIRTUAL CURRENCY BASED ONLINE SOCIAL WAGERING SYSTEM AND METHOD”, inventors Ashish Joshi and Yogendra Ranade, filed Feb. 3, 2012.

### BACKGROUND OF THE INVENTION

1. Field of the Invention

This invention is in the field of computer and mobile computerized device assisted methods and systems for online cashless (e.g. virtual currency) wagering-like activities.

2. Description of the Related Art

Wagering, which can be defined as a type of gambling which involves risking a sum of money on the outcome of an unsettled or uncertain question or matter (e.g. the outcome of a sporting event) has been done for thousands of years. It is a valued recreational activity, and when the sums of money risked are relatively small, is generally recognized as a valid and morally acceptable leisure activity.

Wagering can be distinguished from other forms of gambling and betting in that the uncertain question or matter is usually the outcome of a future event, or the status of a disputed fact, which once the event occurs or the status of the fact is determined, can be clearly and unambiguously established.

With the proliferation of computer and computer network technology, various forms of online wagering have been proposed. However the Interstate Wire Act of 1961, which prohibited interstate use of the telephone or other wired communications devices for interstate sports gambling, has slowed progress in the field as the wire act has been considered to cover the Internet as well.

The United States legal position with regards to wagering has been rather inconsistent, however, as some types of Internet wagers, such as Internet horse racing wagering are tolerated, while Internet sports wagering is not tolerated. Because, to other countries, these inconsistencies resemble trade barriers, the World Trade Organization has sued the United States over this matter, and indeed the US has admitted that its present policy is in violation of World Trade Organization standards. Various Congressional bills have been proposed in congress to bring US policy more in line with international standards in this area, but at present, the status of the matter is presently still uncertain.

### BRIEF SUMMARY OF THE INVENTION

In contrast to gamblers at a horse race, or bettors at Los Vegas casinos, who may derive their main satisfaction out of winning actual money, consider instead the social dynamics of a group of friends watching the Super bowl together. The group will banter back and forth, and different members will often place small informal bets or “social wagers” with each other. The enjoyment is not in actually winning money, but in the social dynamics, and the fun of being “right” and winning acknowledgment from one's friends as having particularly good judgment in some area. Although the same word “wager” may be used to describe these informal bets among social intimates, the psychology of what is going on is very different from gambling type wagering, because the true reward is through the increased social bonding and status among one's peers, rather than the actual winning or losing of money. The spirit of the invention is to attempt to recreate this type of friendly social wagering interaction between friends, and allow these friends to recreate this social wagering experience using the Internet and various Internet connected mobile devices, even when the various friends are physically separated from each other.

The invention is based, in part, on the insight that most social wagers are informal wagers for small sums of money, which will not make any material difference in the wagerer's lives. Rather, the main value for most social wagers is not in the actual money won, but in the thrill of being “right”, and being recognized by one's peers as having unusually good judgment in a particular area. Thus for many social wagering purposes, the actual use of money is more as a score keeping device. Here the invention provides online social wagering, or wagering-like experience that avoids legal issues by not actually using cash, but rather using virtual currency or other non-monetary scorekeeping device. As a result, the invention provides a social wagering experience that, while outwardly resembling conventional wagering, is legally more like a board game that uses play money.

Although the term “wagering” will be used throughout this specification, it should be understood that this term is actually shorthand for social wagering or a “wagering-like experience” brought to people by leveraging their computer based social networks, which that uses non-money or virtual currency. Thus although for simplicity, the term wagering will be used throughout this specification, it should be understood that the term “wagering” should be interpreted as a “wagering-like experience”, rather than true wagering, because no actual money is bet.

As previously discussed, the invention is based, in part, on the insight that the experience of being able to casually turn to a friend during a sports game, or some other event with the outcome is uncertain, and be able to engage in casual banter and even small wagers is an enjoyable one. Indeed this casual banter and small disagreements are often part of the social bonds between members of various social groups, and can help keep the social group intact. This banter is often very informal, and among close friends, the talk can even boarder on the quasi-insulting because among friends, the normal social barriers on polite conversation are diminished. In a social wagering type situation, such banter is often called “swagger” or “trash talk”.

The invention is based, in part, on the insight that wagering without the bantering experience can be rather sterile and uninteresting. The invention is designed to make such banter a key part of the wagering experience.

The invention is also based, in part, on the insight that in real life, it takes little effort to initiate an informal wager among friends. In real life, creating a wager is often both spontaneous and near effortless. Thus to recreate this effect in an online context, the invention strives to make the effort of creating a wager, also nearly effortless. Indeed the invention strives to streamline the entire process of initiating a wager, engaging in online banter, determining who was right, and collecting on the wager.

As will be discussed, the invention's virtual currency based online social wagering system and method is designed to incorporate all of the above insights. It is based on at least one Internet based wagering network server, which can handle wagers initiated by multiple users using commonly available Internet connected computerized devices such as Smartphones/tablets/computers and the like. Users can either be drawn from various computerized social networks (exemplified by Facebook, Twitter, Google+ and the like), and these users can also include Internet connected users who are not members of computerized social networks as well. Users may interact with the wagering network server using either a standard web browser mechanism, or through a downloadable application.

The system avoids legal problems through the use of virtual currency, facilitates interactions between friends by drawing upon social networks, and is designed to make friendly social interactions such as banter, “trash talk”, or “swagger” a key part of the wagering experience. Additionally, through the use of various internal accounting controls, the system helps insure basic fairness and accurate assignment of the wagering virtual currency to the proper recipients.

Such “swagger” often uses relatively course language, which is understood by the users in context to not have any intent to offend, but merely to add color and emphasis. In a number of the figures, examples of such “swagger” have been shown with a certain amount of light editing or redactions in order to avoid distractions.

### BRIEF DESCRIPTION OF THE DRAWINGS

FIG. 1 shows an overview of the wagering network server, other social network servers (e.g. Facebook/Twitter) and non-social network servers, and the various network connected computerized devices (e.g. Smartphones/tablets/computers) that can be used by the various initiating wagerer users and receiving wageree users. Note that in some cases, users may interact with the wagering network server through a user interface presented by a social network server (e.g. though a Facebook interface, for example).

FIG. 2 shows an example of the system landing page as seen on a user Smartphone.

FIG. 3 shows the initial process of starting a wager.

FIG. 4 shows the steps of entering in additional wager parameters.

FIG. 5 shows the steps of selecting various friends to invite to the wager.

FIG. 6 shows the steps of selecting various groups of friends to invite to the wager.

FIG. 7 shows a summary page showing previous wagers that this user has initiated.

FIG. 8 shows a summary page showing wagers where this user has been invited to participate.

FIG. 9 shows a wager/bet page, with details of the bet, and banter or commentary (i.e. ‘swagger board’) between various friends that have been invited to participate in the bet.

FIG. 10 shows a screen with various system notifications.

FIG. 11 shows a screen with various system offers.

FIG. 12 shows a user interacting with the wagering network server and system through a web browser and the user interface of a social network. Here the user is chatting with a friend, and a friendly disagreement starts to begin.

FIG. 13 shows a user interacting with the wagering network server and system through a web browser and the user interface of a social network. Here the user expresses his point of view on the matter.

FIG. 14 shows a user interacting with the wagering network server and system through a web browser and the user interface of a social network. Here, after further discussions, the two friends have called upon the wagering network server (here called “Betville”), to formalize the wager. Note that here, the wagering network server has been called from within the social network user interface.

FIG. 15 shows the same discussion and wager from the standpoint of the other user, who may be interacting with the wagering network server and system through his Smartphone.

FIG. 16 shows a user interacting with the wagering network server and system through a web browser and the user interface of a social network. Here the user is able to completely set up a wager on the wagering network server from within the user interface of the social network.

FIG. 17 shows the splash screen for the iOS version of the Betville app.

FIG. 18 shows the login page for the Betville app.

FIG. 19 shows the Betville home screen.

FIG. 20 shows the Betville “Select type of bet” screen.

FIG. 21 shows the Betville “Enter bet details screen”.

FIG. 22 shows that Betville users can either invite individual friends to a bet, or define various groups of friends as standing betting groups which then can be used for subsequent bets.

FIG. 23 shows the Betville “My Bets” status screen, which shows an overview of the various types of bets presently or recently pending in the system.

FIG. 24 shows the screen for settling a simple bet.

FIG. 25 shows the screen for settling a pool bet.

FIG. 26 shows a miscellaneous function screen.

FIG. 27 shows a screen that allows the user to purchase additional virtual currency.

### DETAILED DESCRIPTION OF THE INVENTION

### Definitions

For the purposes of this specification, a computer social network, exemplified by Facebook, Twitter, and Google+, is a website that allows users to create public or private available profiles of themselves, and also create relationships with other website users who interact with their publically or privately available profile. At least some of these relationships will be exposed to authorized users who visit this publically or privately available profile. Additionally users can participate even if they are not part of a social network but by downloading this application on Smartphones/tablets and the like by creating a unique user account.

System users (e.g. individuals) who initiate a given wager will be termed initiating wagerer users, while other users who receive and accept that given wager will be termed receiving wageree users. So for any given wager, the wagerer initiates, and the wageree accepts.

For the purposes of this specification, social wagering is defined as wagering among socially connected members, rather than wagering between strangers, so that the wager has at least some social content.

As previously discussed, the invention may be viewed as being a method and system of virtual currency based wagering. The invention is a software-implemented invention, and draws upon computer network technology, particularly Internet technology for its implementation. Usually the main part of the invention's software will reside on at least one wagering network server. However in some embodiments, part of the invention's software may also reside as a plurality of software applications “apps” running on various user computerized devices, as well as web sites such as Social Networking web sites.

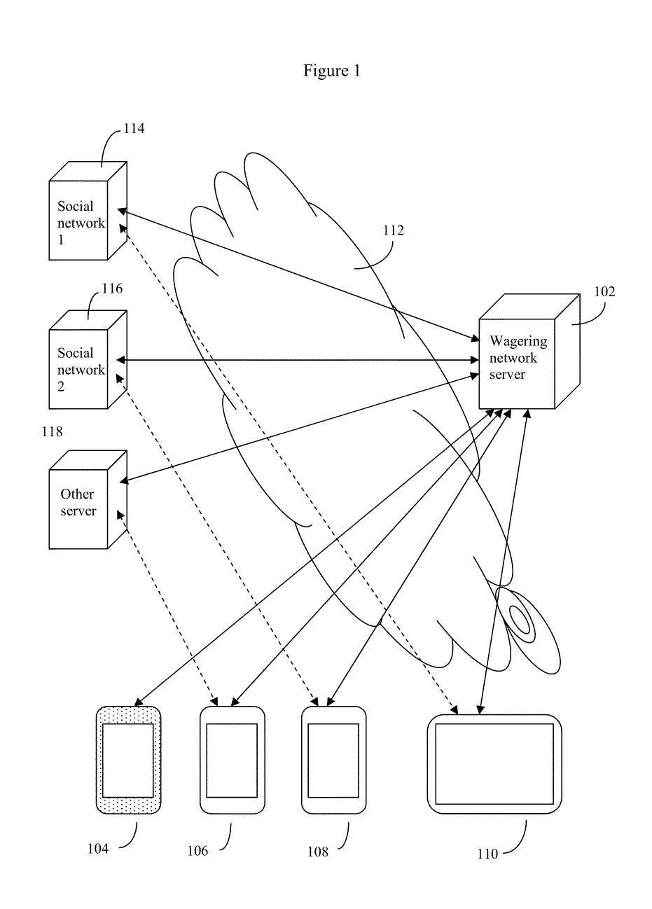

FIG. 1 shows an overview of the wagering network server, other social network servers and non-social network servers, and the various network connected computerized devices (such as Smartphone's) that can be used by the various initiating wagerer users and receiving wageree users.

This method and system will typically comprise at least one wagering network server (102) comprising at least one processor, memory and wagering server software, and a plurality of network connected computerized devices such as Smartphones (104, 106, 108), tablet computers (110), laptop computers, desktop computers and the like (not shown). Each of these computerized devices will typically comprise at least one processor, memory, network connectivity, and a graphical user interface.

Here, person wishing to place a wager, here called the initiating wagerer user, will use at least one of these computerized devices (for example device (104)) to establish contact with the wagering network server (102) over a network such as the internet (112), and initiate at least one wager. This wager will, for example, typically comprise a wager topic regarding the outcome of an unsettled matter (e.g. various upcoming public events, such as the outcome of a presidential election, or the outcome of a sporting game), wager terms, a wager end date, and a list of individuals or groups invited to participate in the wager. The wager terms will usually be a bet of a specific amount of virtual currency, with the exact amount to be defined by the initiating wagerer user, or odds of return of a return amount of virtual currency in response to a bet amount of virtual currency, which again will usually be set by the initiating wagerer user.

Typically at least some of the various individuals or a group that the initiating wagerer user will in turn contact to communicate the wager to will often be drawn from at least one of the initiating wagerer's computerized social networks. Here, these computerized social networks are exemplified by the server(s) for social network 1 (114) and social network 2 (116). Examples of such computerized social networks include Facebook, Twitter, Google+ and the like, and in some of the drawings, these will be exemplified by Facebook icons (f) and Twitter icons (t).

Additionally, other individuals known to the initiating wagerer user, who have access to the internet and thus a way to communicate with the initiating wagerer user by other methods and servers (118) (e.g. email servers and the like) may also be included as well.

The persons invited by the initiating wagerer user are here termed the receiving wageree users, and typically when the invention is in operation, at least one receiving wageree user will receive this at least one wager using at least one computerized device, and use the graphical user interface of their device to accept this wager. Of course others may also decline the wager as well.

Typically, when the wager end date is reached, the outcome of the wager must be determined. This can be done by the initiating wagerer user, or a designated trusted party, or in some cases automatically or manually by the wagering network server (102) itself. Once the outcome of the wager is determined and entered into the system, the winner or winners of the wager then become apparent, and the wagering network server (102) can then distribute the bet amounts of virtual currency among the various individuals participating in the wager. This virtual currency will be typically distributed into virtual currency accounts assigned to the initiating wagerer and the various receiving wagerees. In use, over many wagers, the same user may act as the initiating wagering user on some wagers, and as the receiving wageree user on other wagers.

As previously discussed, although this system and method can work with all types of network connected computerized devices, often the network connected computerized devices will be Smartphones, exemplified by the popular Apple iPhone and Android series of Smartphones. These devices are typically connected to the Internet (112) through various wireless links, such as cellular wireless connections (e.g. 3G, 4G wireless connections, and the like), WiFi wireless links, and other wireless connectivity methods.

When connecting to standard desktop, laptop, and tablet computerized device with larger screens (e.g. screens over about 6″ diagonal measurement), often the wagering network server (102) may function by serving web pages to web browsers running onboard the various computerized devices. When smaller screen sized devices, such as Smartphones are used however, although web pages can also be served, often it will be convenient to install a customized wagering application software package, or “app”, onboard the Smartphone, which will format the data in a small-screen friendly manner. In this case, wagering network server may not serve web pages, but instead may use alternate data formats for sending and receiving data from the wagering apps onboard the various Smartphones. Such apps can also be used for larger screen devices as well (e.g. tablet computers), however.

Although the wagering network server (102) can, in the simplest mode, simply use the various social network servers (114), (116) as a convenient method to obtain a list of promising wagering contacts for a particular wagering user, in other embodiments, the social networks may be more heavily involved in the process. For example, the wagering network server (102) can push wagering invitations to the social network server so that, for example, a Facebook user can receive an invitation to place a wager from his or her Facebook page. Alternatively the wagering network server (102) can also harvest additional information, such as comments typed in by a wagering invited Facebook user using the Facebook interface, and publish these comments to other wagering users as part of the ongoing banter, “trash talk”, or “swagger” regarding a wager of mutual interest.

As previously discussed, this wager related banter, “trash talk” or “swagger” is a key part of the invention because it helps form and maintain social bonds between the various participating members, which is one of the primary rewards for using the system. This bantering session will generally be automatically established by the wagering network server (102) at the time that the initiating wagerer user first establishes a particular wager. When this is done, the list of individuals or groups of individuals invited to participate in this particular wager are put into mutual contact, and they can thus engage in cross-banter with each other. Often this banter will be in the form of text messages, but other forms of data transfer, including emoticons, images, sound files, video files, and the like can also be exchanged by way of wagering network server (102).

In order to conduct a fair and honest system, the wagering network server (102) will also do quite a bit of bookkeeping. Generally each user will have his or her own account, which will be initially assigned a certain level of virtual currency, such as $100 virtual dollars. Users will be able to add to their individual accounts by various methods including buying virtual currency (e.g. one real dollar=$10 virtual dollars), by purchasing various levels of membership (e.g. paying a monthly fee for a certain number of virtual dollars each month, and also for getting higher privileges on the system) by viewing advertisements that various sponsors may pay the user to view, and other standard promotional methods. Depending on their history of successful wagers, each user's account may further be supplemented or reduced. Thus users with a consistent history of winning may get additional rewards (e.g. more virtual currency, more privileges, etc.).

Note that depending upon prevailing US and international law regarding wagering, wherever wagering for money is illegal, the system will not permit funds to be withdrawn. However in some embodiments, at least in local contexts where wagering for money is legal, then the system may optionally be enabled to allow users to convert virtual currency to real currency, and withdraw real currency from the system.

Various types of bookkeeping methods can be used. One important bookkeeping device is to ensure that the initiating wagerer user doesn't place a wager that larger than the ability of that user's account to cover. To do this, generally the wagering network server (102) will keep track of the status of a virtual currency account assigned to the initiating wagerer user, and block entry or give error messages when the user attempts to create a wager that exceeds the limit of the user's virtual currency account.

In order to encourage participation, the system may also provide the user with additional amounts of virtual currency according to their previous history on the system. Thus for example, frequent users may be rewarded with additional virtual currency and or system privileges.

It is anticipated that the average user may have a number of wagers ongoing simultaneously. In order to help the user manage these various wagers, the system will allow the users of the various computerized devices (e.g. 104, 106, 108, 110) to interrogate the wagering network server (102) regarding the status of some or all wagers initiated by that particular user, or some or all wagers accepted by that particular user, some or all wagers rejected by that particular user, some or all wagers which have expired, and some or all wagers which are now closed to further bidding.

In order to better illustrate the system and method, various example screenshots of what a user, such as an initiating wagerer user, will see when interacting with the wagering network server (102) using a device such as a Smartphone (104) using a wagering application are shown.

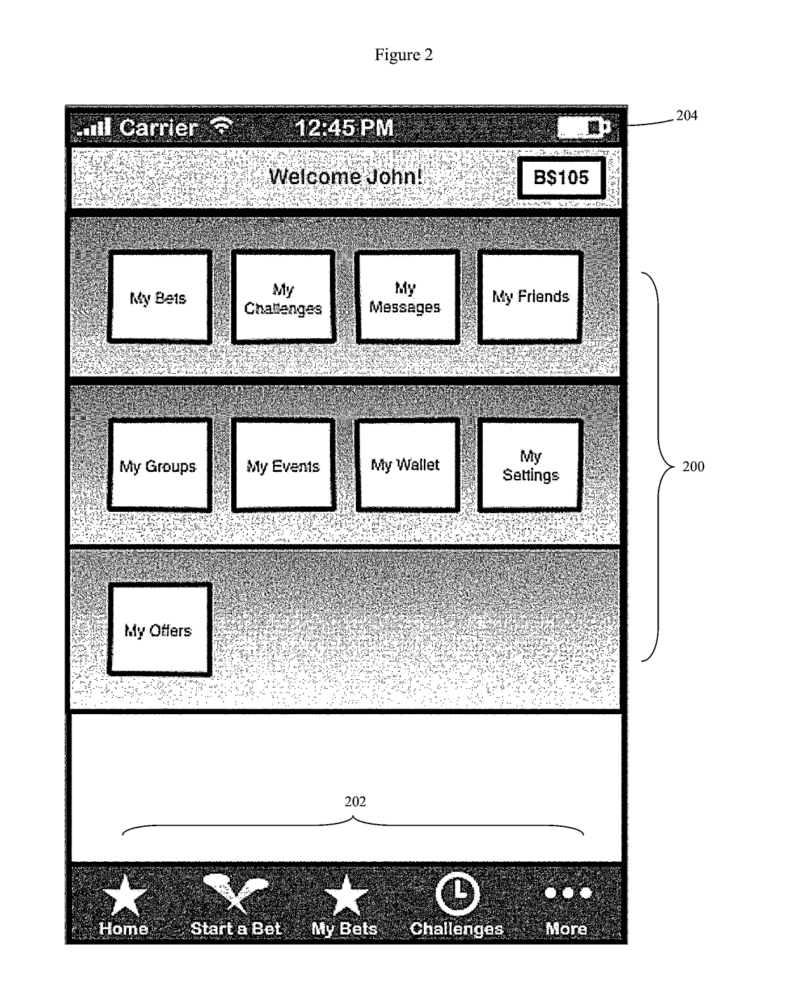

In many embodiments, either initially or soon after initiating a session with the wagering network server (102), the user will be directed to a system landing page, which will give the user a variety of options on how to proceed. This is shown in FIG. 2. Here the various icons (200) correspond to various options that the user can choose to invoke, such as “my bets”—a list of the bets or wagers that this user is currently involved with; “my challenges”, a list of wagers that this user has currently initiated or attempted to initiate; “my messages”, a list of messages to the user; “my friends” a list, often constructed with the aid of input from various social networks, of various individual friends that the user can invite for a wager; “my groups” pre-selected lists of friends often chosen from the same social circle that the user can invite for a wager; “my wallet”, a control page for the user's virtual currency account' “my settings”, a control page for the user's various system settings'; and “my offers”, a list where the user can view various system offers and promotions, are shown. Other options may also be added.

Additionally, the most frequently used system options, such as home (e.g. return to this screen), “start a bet”, “my bets”, “challenges” and “more” can also be seen on the bottom of the screen (202).

The status of the user's virtual currency account is shown as (204). This user currently has $105 dollars of virtual currency available for wagering.

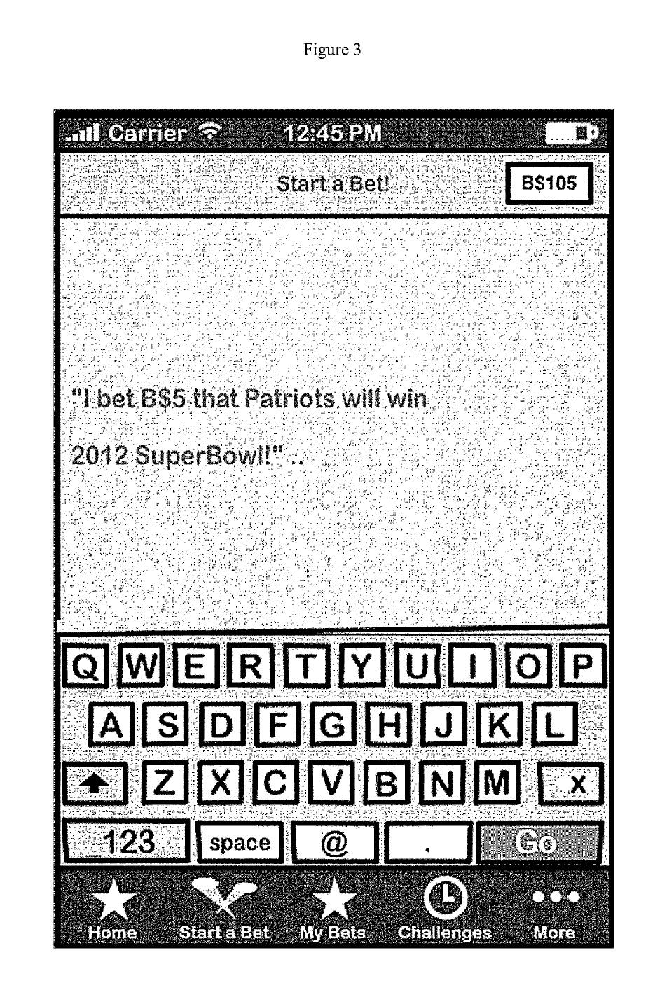

For example, assume that the user wishes to start a new wager or bet, and to do so clicks the “start a bet” icon from group (202). This takes the user to the screen shown on FIG. 3, which shows the initial process of starting a wager. Here the user can formulate the “outcome of an unsettled matter” (here the outcome of a soon to be held sporting event), by stating the name of the event, the predicted outcome, and the amount of virtual currency wagered as a pithy statement such as “I bet B$5 that Patriots will win 2012 Super Bowl!” This can be entered using the Smartphones native typing interface, or by other method.

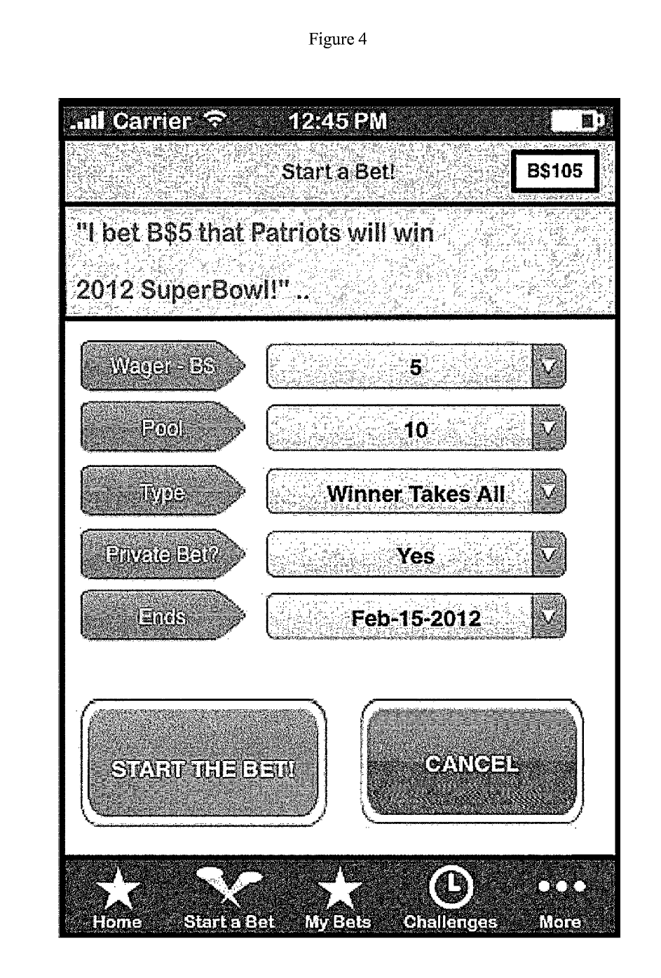

After typing in the general parameters intended for other users to read, the user will then inform the system about the other betting parameters. FIG. 4 shows the steps of entering in these additional wager parameters. Here the user intends to create a winner take all betting pool, composed of 10 friends, where each participant would enter in $5 in virtual currency.

Bets can be public or private. Public bets can be seen by anyone participating in the system, while private bets are restricted to invited members, which are usually members of one or more of the user's social groups. Here the user is creating a private bet.

The bets also have an end date, which in this case is Feb. 15, 2012, a few days after the end of the 2012 Super Bowl.

Other types of bets can also be initiated, these include:

1 Wagering on the actual scoreline of a particular game. The user who correctly predicts the score of the game or is the closest amongst the wagerers wins the wager
2. Wagering on public outcomes such as elections with known market odds. These odds can be obtained from legal betting sites
3. wagering on common public outcomes but by offering a custom odds. For instance other platforms might offer 1:3 odds for Obama to win the 2012 election; however user can create any odds for this event, for example by offering 50:50 odds to his friends.

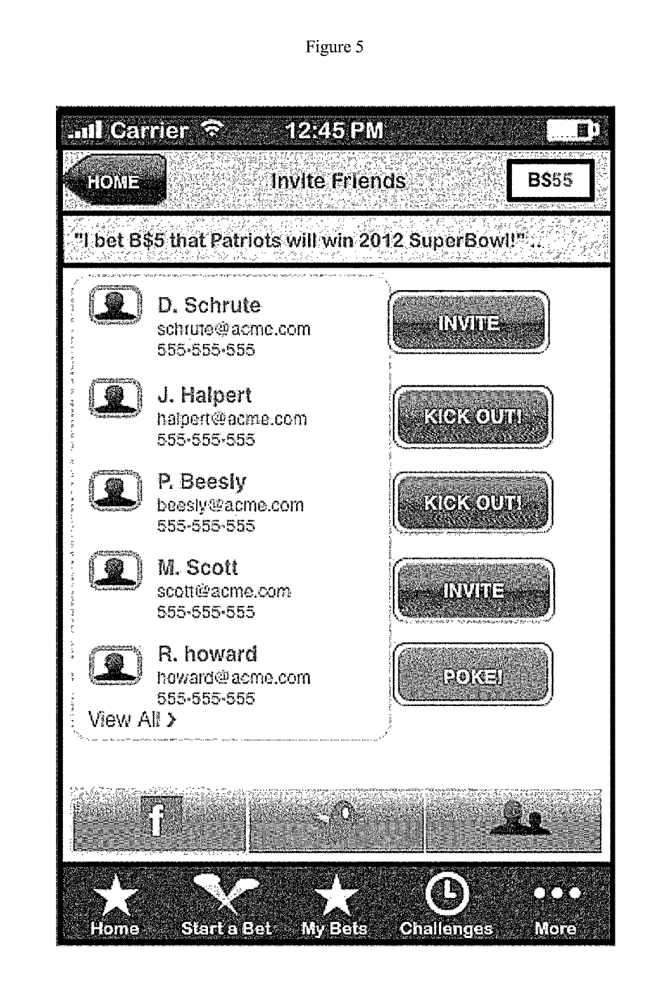

Next, after establishing the main wager/bet parameters, the user then goes on to select the various friends that he wishes to invite to the wager. These friends can be individually chosen from an address list, which can be initially populated by the user's friends lists from various social network servers (114), (116) or other servers (118). An example of the user choosing (and rejecting) various friends from an individual list is shown in FIG. 5. The user has decided to invite two friends, not invite (kick out) two other friends, and send a message to Facebook “poking” a third friend, but not necessarily inviting him to the wager.

Note that this screen also allows the user to interrogate various social network servers (e.g. 114, 116) here exemplified by Facebook and Twitter to find additional friends to invite to the wager.

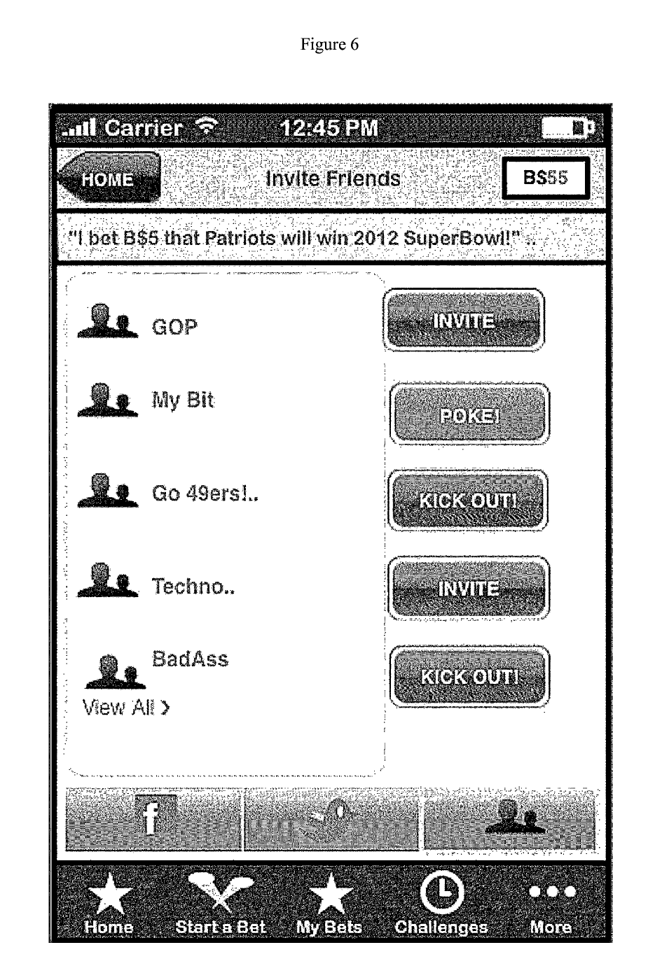

In additional to individual friends, groups of friends, such as from various social network circles of friends, may also be invited or not invited to wager as a group. An example of such a group oriented invite system is shown in FIG. 6. Here the user has decided that his political friends and friends with common technology interests may be interested in joining the wager, but his group of friends noted for support for the rival team the 49'ers is unlikely to be interested in participating, and thus has decided to not invite this group. Again this page also provides a link to interrogate various social network servers (e.g. 114, 116) here exemplified by Facebook and Twitter (Google+ would also be a good candidate) to find additional groups of friends to invite to the wager.

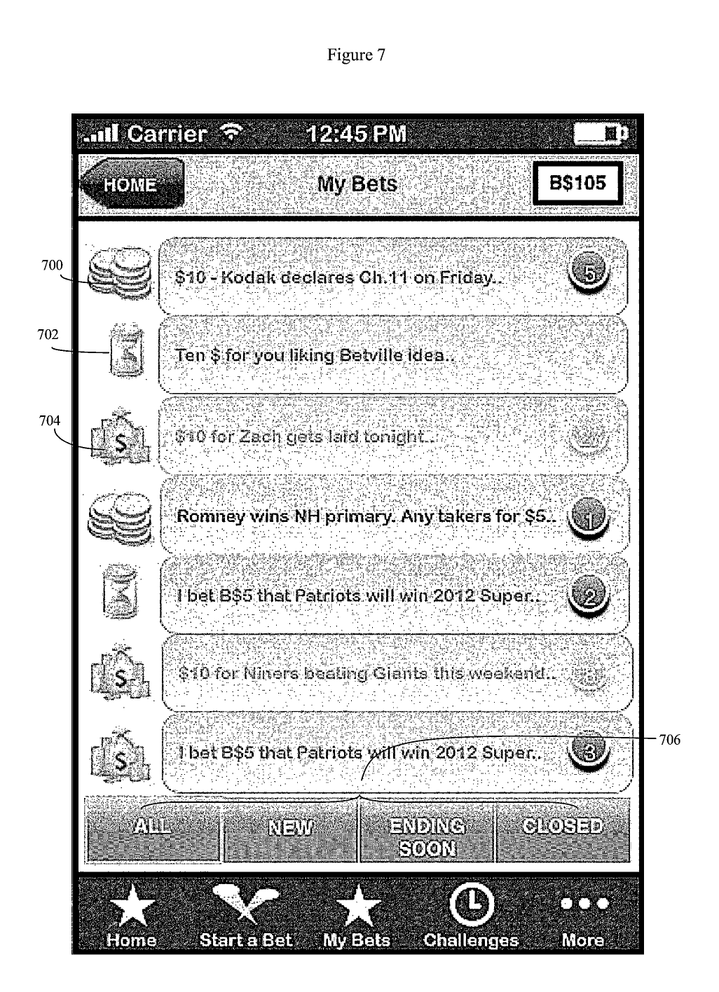

In order to help manage the process, the system will also provide various summary pages. For example, FIG. 7 shows a summary page showing previous wagers that this user has initiated. Here the icon of a stack of coins (700) can signify that the wager has at least some participants and is in progress, the hour glass icon (702) can signify that the wager is new and is awaiting participants. The moneybag icon (704) can signify that the wager is fully subscribed, and is thus not open to additional participants.

In this example, the system also allows the user to sort his bets and either show all bets, just the new bets, the bets that are ending soon, or the closed bets, by using additional control icons (706)

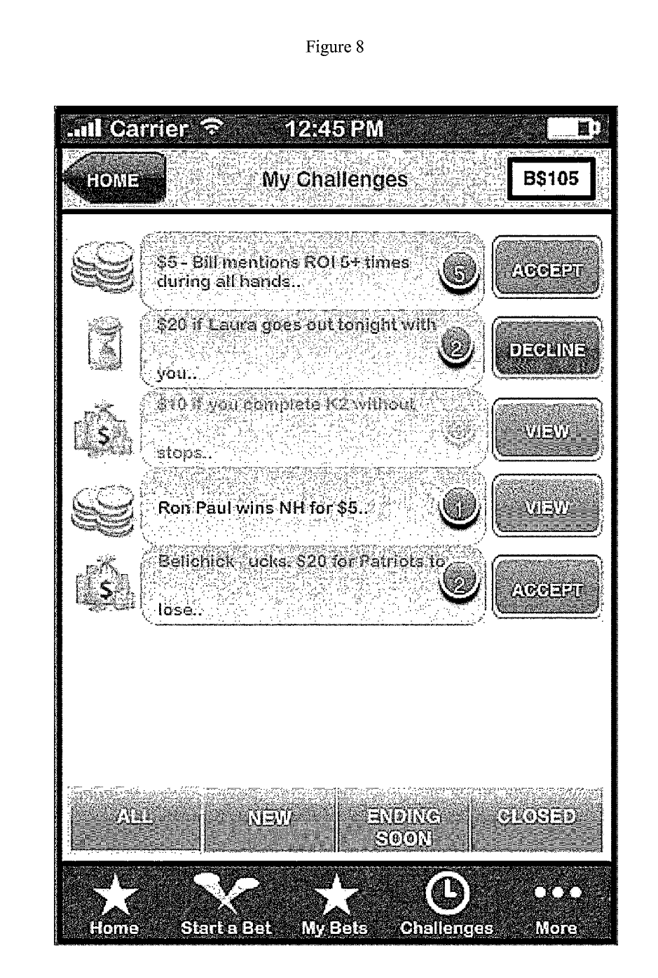

FIG. 8 shows a summary page showing wagers where this user has been invited to participate as a receiving wageree user. In other words where the user has been challenged to some other person's wager. Here the user has decided to accept two, decline one, and not take action yet on two others.

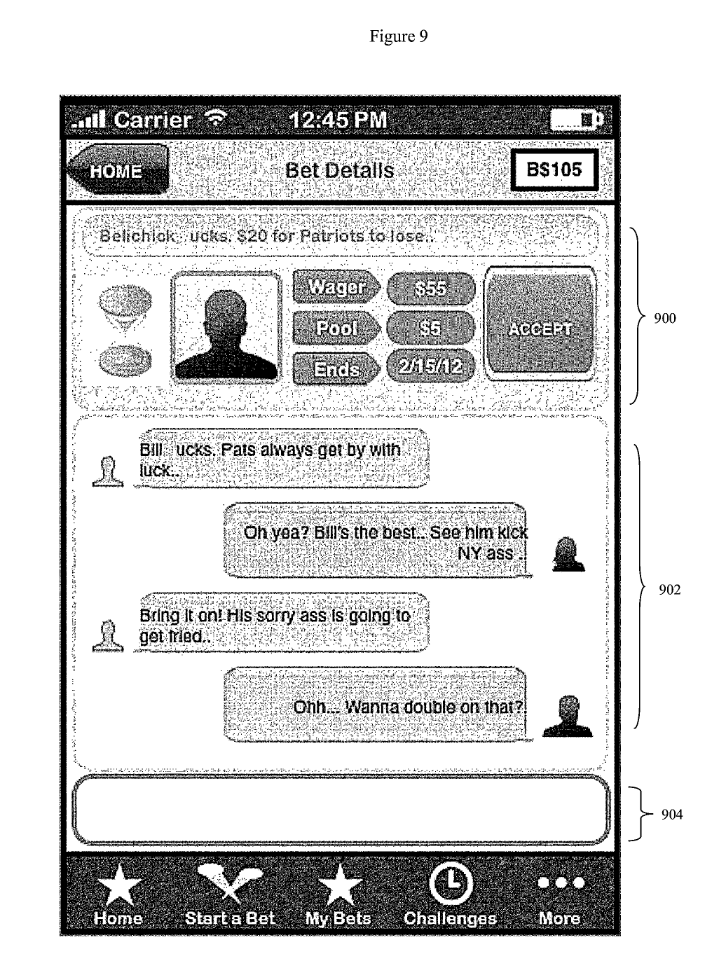

As previously discussed, one important aspect of the invention is the way that it combines both wagering and social banter (“trash talk”, “swagger”) into a single online experience. This combined experience is shown in FIG. 9. At the top part of the screen (900), details of that particular wager may be seen. On the lower part of the screen (902) the various users invited to participate in that particular wager are bantering among themselves. At the bottom of the screen is a dialog box (904) where this user may add his own message (e.g. “banter”, “trash talk”, ‘swagger” to the ongoing dialog. These messages will all be carried back and forth between various user devices (104, 106, 108, and 110) by way of wagering network server (102), and in some cases by participating social networks (114), (116).

As previously discussed, these messages may be of various sorts, including text messages, SMS messages, and the like, but more sophisticated message formats including various multimedia message formats may also be used.

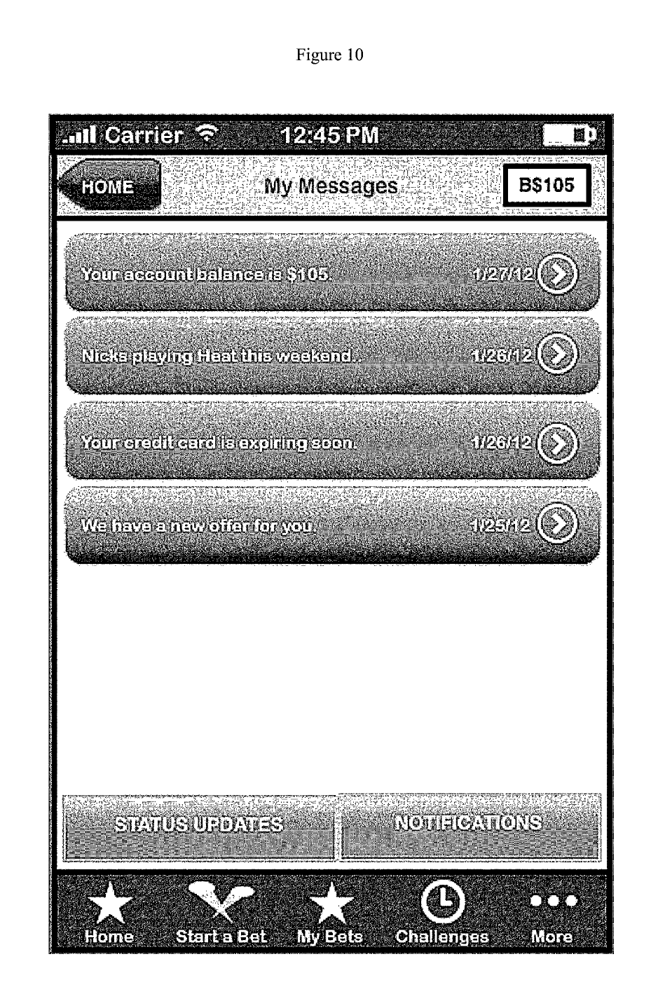

The wagering network server (102) and system will also occasionally need to send system account maintenance messages or notification messages to the various users. An example of such system notifications is shown in FIG. 10.

FIG. 10 shows a screen with various system notifications. Each notification can lead the user to the appropriate screen that furnishes additional details about the notification. For example, an offers related notification may lead the user into ‘My Offers’ screen, while a balance & payment related notification may lead the user into ‘My Wallets’ screen. Similarly an event related notification may lead user into a screen that allows user to start a bet on the event described by the notification.

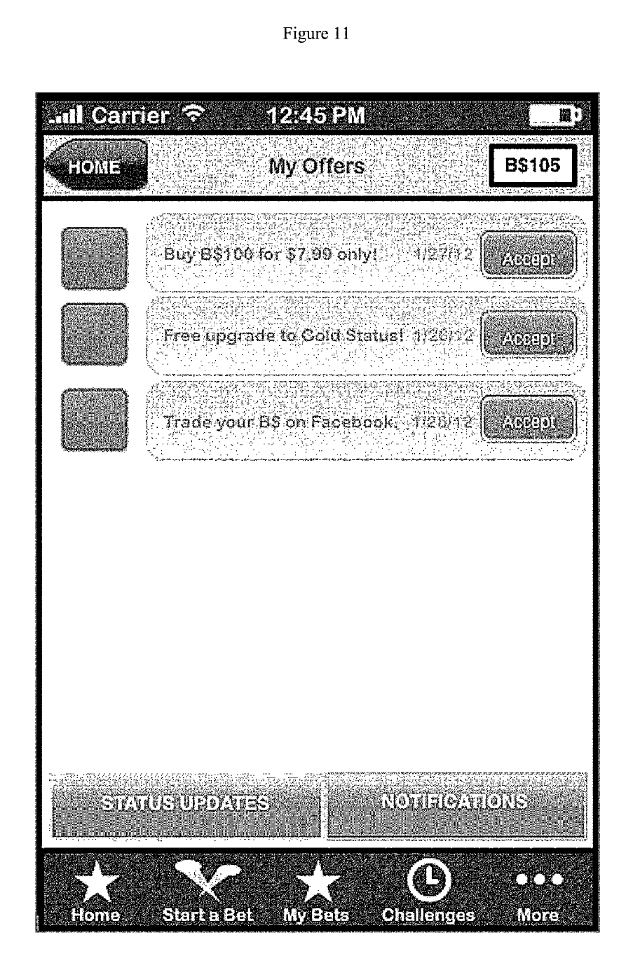

Additionally, for marketing and promotional purposes, the operators of the wagering network server (102) may occasionally wish to send various offers to the participating users. An example of such system offers is shown in FIG. 11.

Although in many embodiments of the system, the various users involved in a wager will typically know each other due to their pre-existing social networks, this need not always be the case. In some embodiments, certain types of wagers may be designated as public wagers, in which case these wagers may potentially be open to any user of the system.

Although, in many embodiments of the system, wagers will be made explicitly (that is by way of an initiating wagerer user creating a wager and inviting participants), in other embodiments, there need not be an explicit wager invitation, but rather simply a user making a proclamation or expression of a willingness to offer either a public or private wager. An example of such a proclamation may be seen in FIG. 9 (902), where in the context of banter for a first wager, one of the wager invitees has in essence proclaimed an interest in setting up a second wager by saying “Ohh. wanna double on that?” Here, in some embodiments, the system can facilitate such pre-wager discussion by providing various chat sessions and other interactive sessions where various users can communicate informally.

Further Discussion of Accessing the Wagering Network Server from Within the Web Browser Based User Interface of a Social Network.

As previously discussed, in some embodiments it may be useful for the operators of the wagering network server to come to an agreement with the operators of one or more social networks wherein the functionality of the wagering network server, or at least key wagering network server API, can be accessed from within the web page based user interface of the one or more social networks. Here Facebook, which has various types of embedded third-party applications running on various third party servers, is a good example.

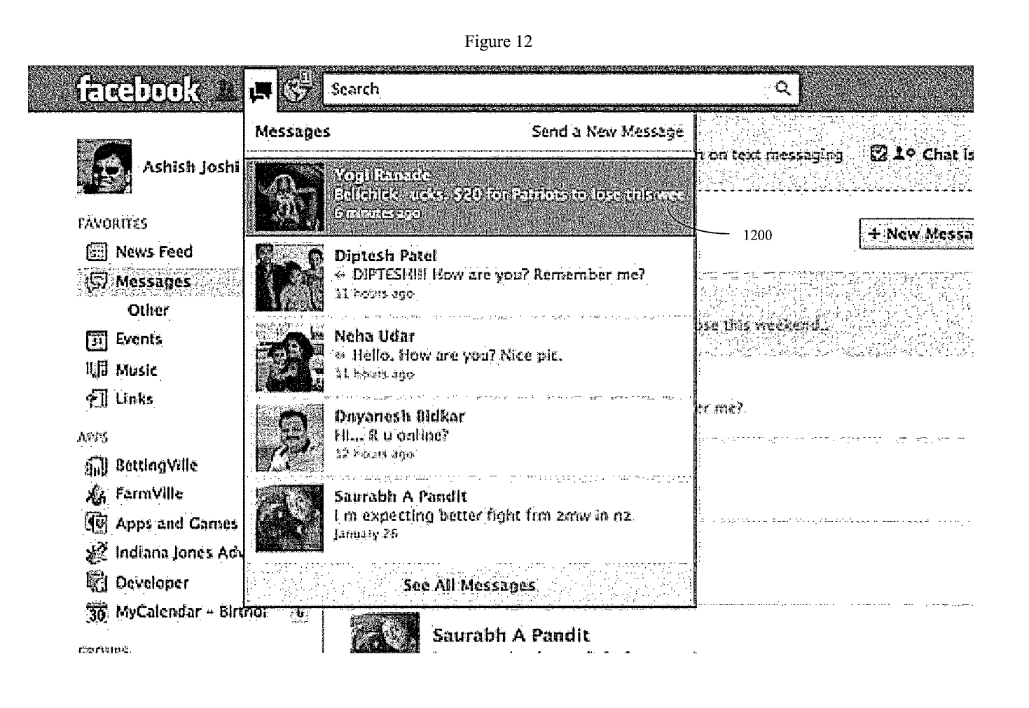

FIG. 12 shows a user interacting with the wagering network server and system through a web browser and the user interface of a social network. Here the user is chatting with a friend, and a friendly disagreement starts to begin (1200)

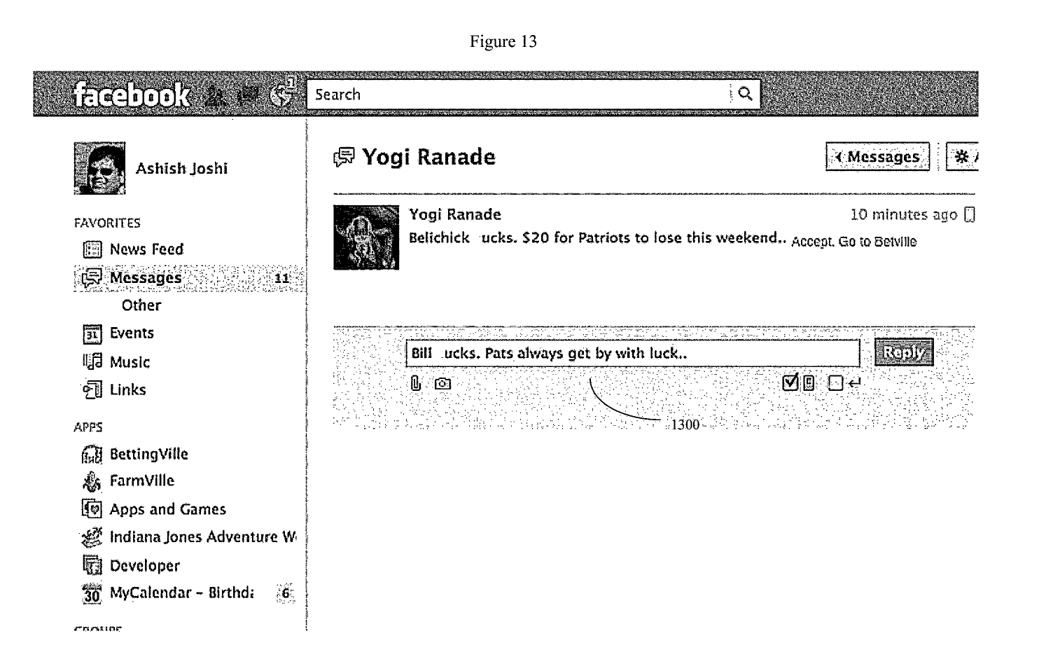

FIG. 13 shows a user interacting with the wagering network server and system through a web browser and the user interface of a social network. Here the user expresses his point of view on the matter (1300).

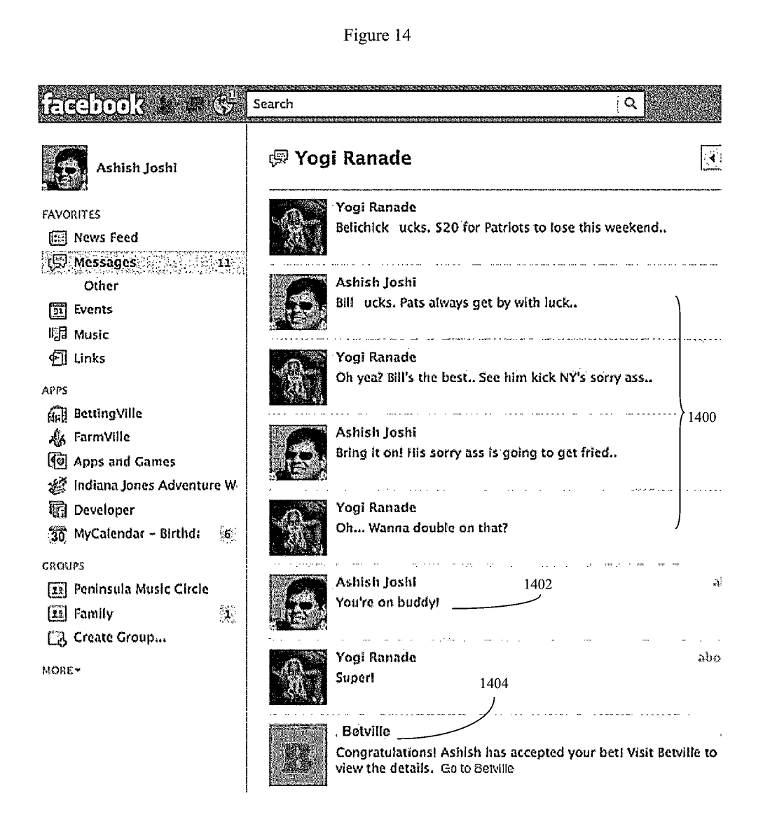

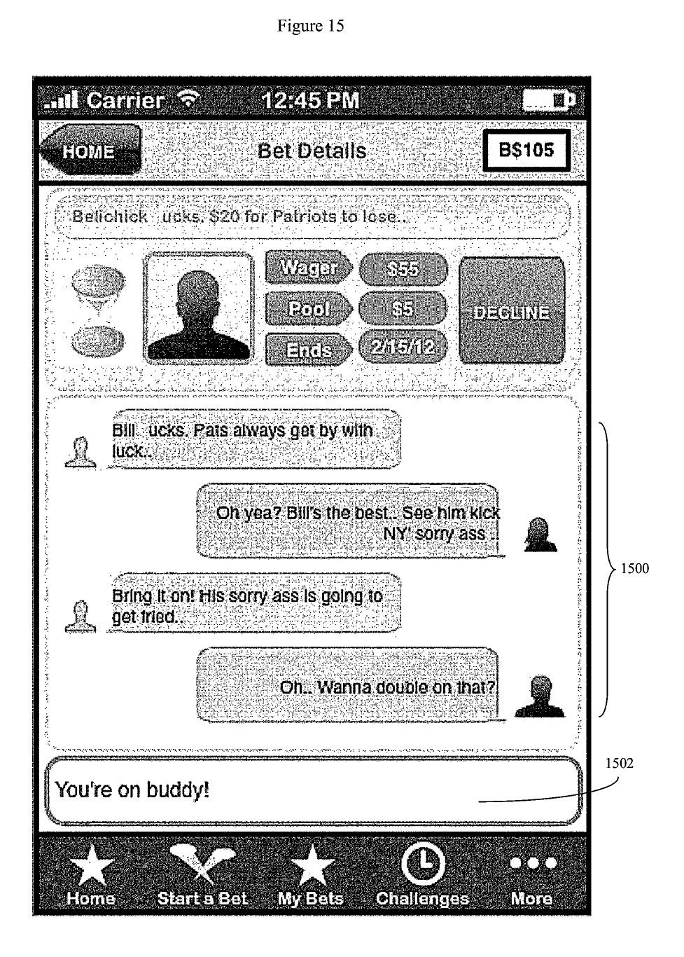

FIG. 14 shows a user interacting with the wagering network server and system through a web browser and the user interface of a social network. Here the two friends have decided to place a wager on the issue. The social network interface shows their subsequent discussion (1400), (1402), as well as formal notification from the wagering network server (here called “Betville”), that the wager is on (1404). Note that the wagering network server may be called from either within the social network user interface, or directly such as via the mobile app on FIG. 15.

FIG. 15 shows the same discussion and wager from the standpoint of the other user, who here is interacting with the wagering network server and system through his Smartphone. Note that the last part of the discussion (1500) and this user's latest response (1502) can also be seen in the other user's social network based interface as (1400) and (1402).

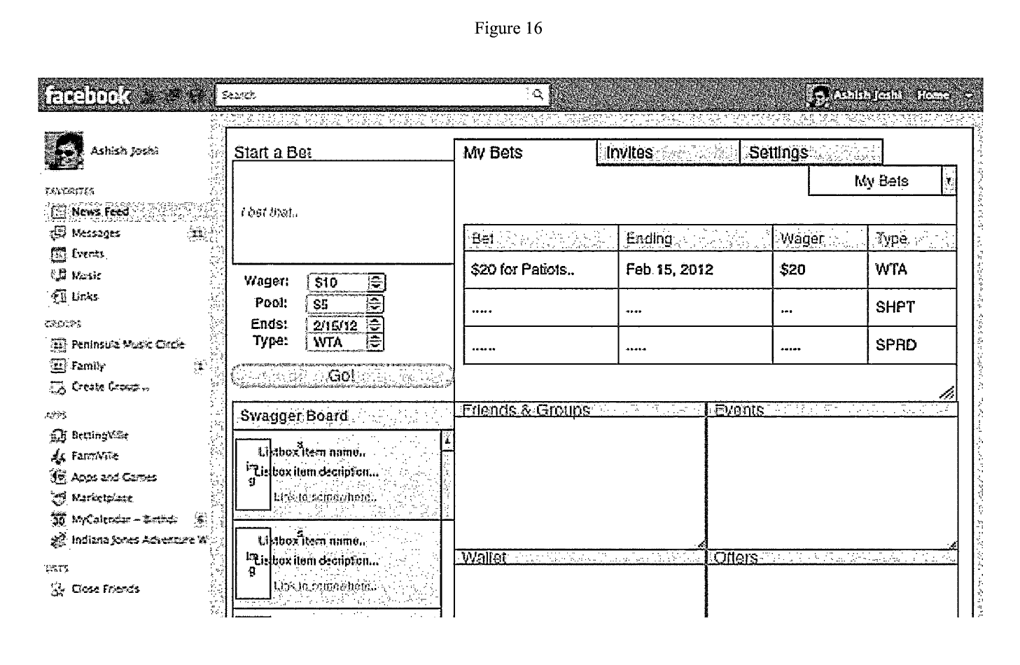

FIG. 16 shows a user interacting with the wagering network server and system through a web browser and the user interface of a social network. Here the user is able to completely set up a wager on the wagering network server from within the user interface of the social network.

In some embodiments, a user can start the wager from a mobile device (e.g. iPhone). The wagering network server's web-based platform can enable the functionality and cross-platform handshake for two-way messaging between the mobile device and users presently logged in to a social network. The wageree will receive the notification of the wager on Facebook, and can accept the bet from the Facebook platform (i.e. within the Facebook web browser based user interface). When the user clicks ‘Accept’ on facebook, user could be navigated to the appropriate wagering interface.

Based on the above considerations, an iOS app and an Android app, both called “Betville”, were developed. The Android version of Betville was released on Android on Sep. 21, 2012, and the iOS version of Betville was released for iOS on the Apple iTunes store on Jan. 15, 2013.

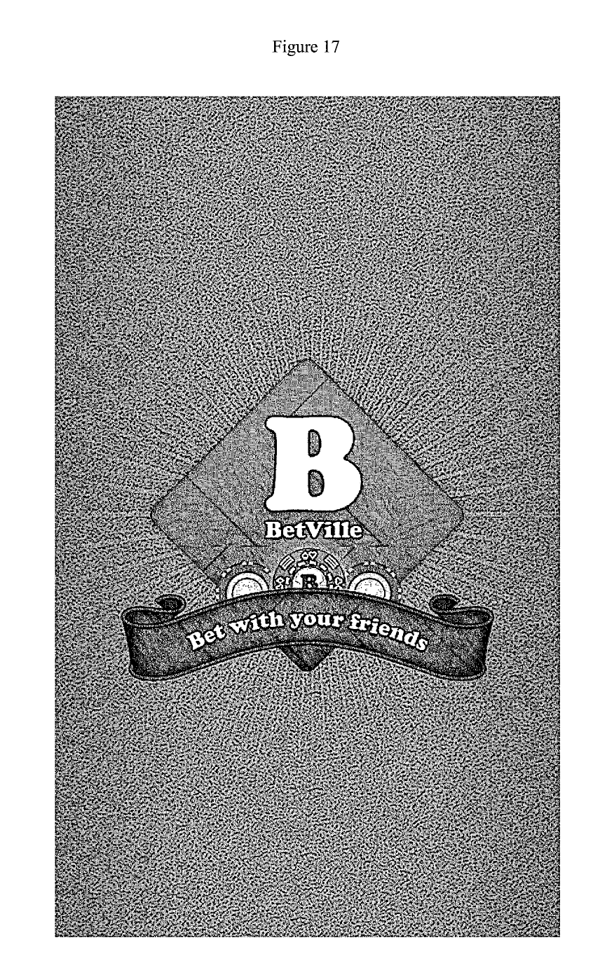

FIG. 17 shows the splash screen for the iOS version of the Betville app.

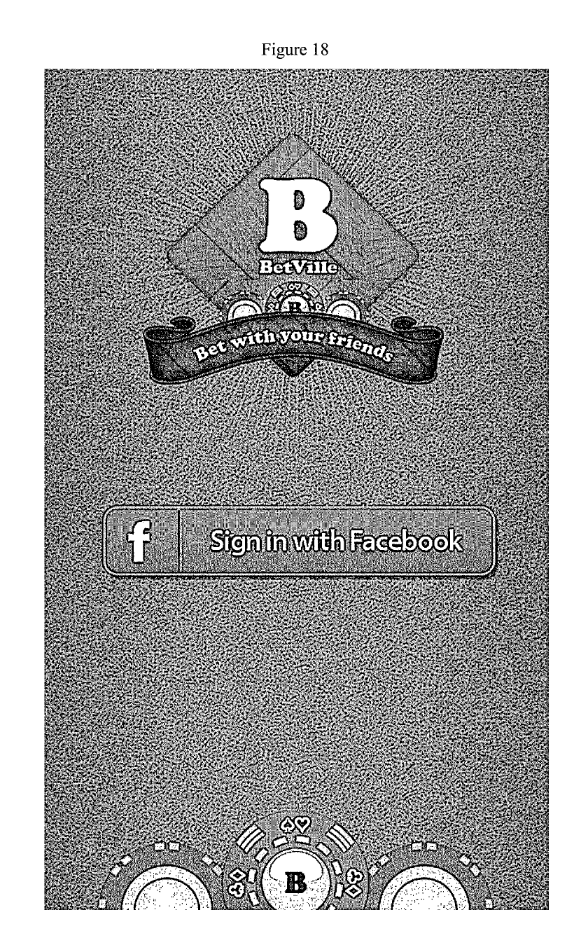

FIG. 18 shows the login page for the Betville app, which is generally shown to first time users. Here users are invited to log in with their Facebook or other online social network account.

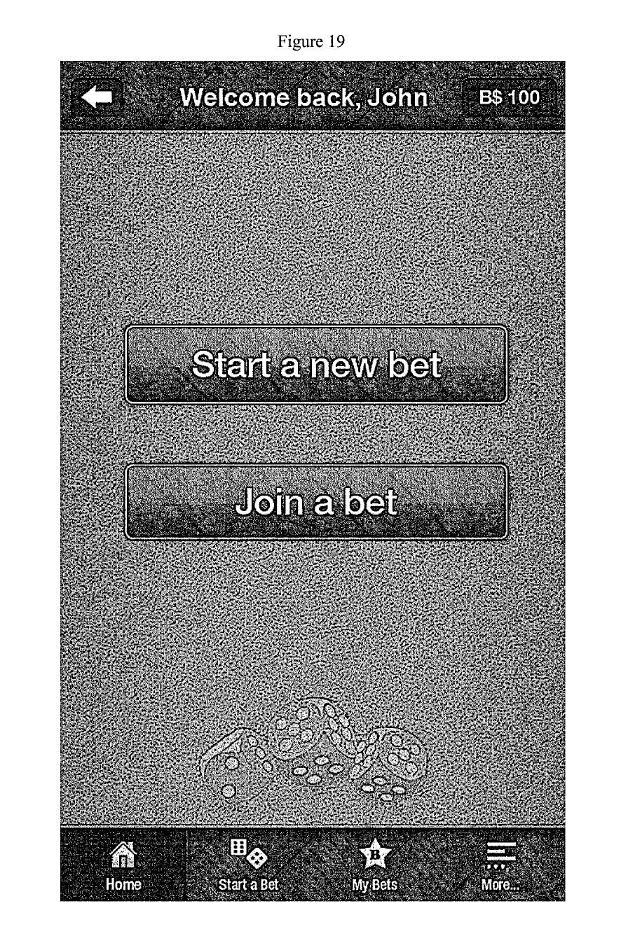

FIG. 19 shows the Betville home page where the user is asked if he or she wishes to start a new bet or join an existing bet. Underneath this is the script menu which includes home, start a bet, my bets, and more.

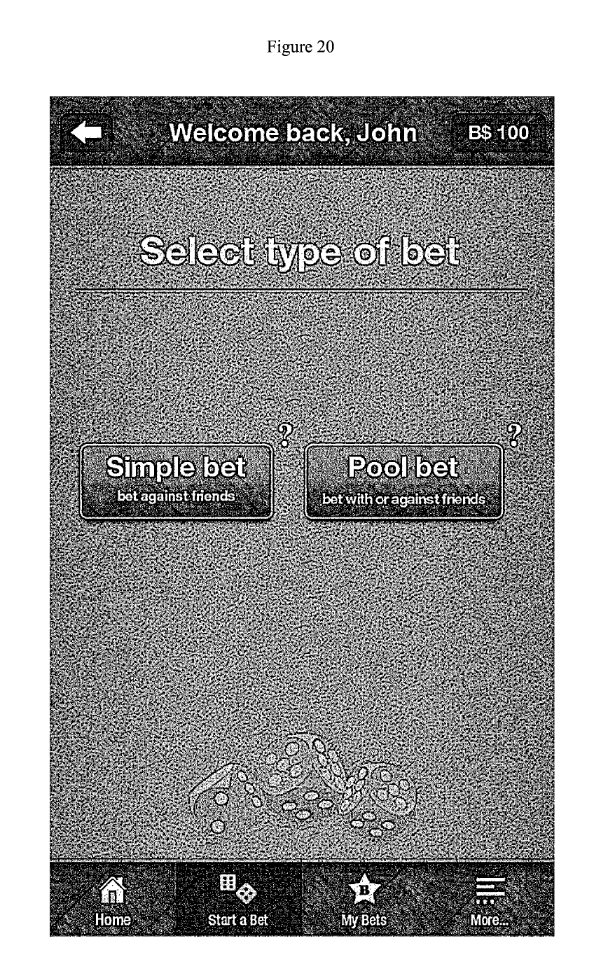

FIG. 20 shows that if the user selects “Start a new bet”, the app takes the user to a page which allows the user to select what type of wager the user desires to start. The system presently allows the user to select either simple bets or pool bets. Both types of wagers cover situations where there is a binary “yes/no” type outcome to the wager.

Simple bets can represent more of a higher risk, higher potential return type wager. Here the amount of virtual currency that the user puts at risk is only limited by the number of opposing wagers on the opposite side of the bet. Thus for example, if a first wagerer bets $5.00 on a particular bet outcome, and 5 opposing wagerers each bet $5.00 against that outcome, the total amount of the wager is $30. If the first wagerer wins, he gets his initial $5.00, as well as the 5*$5.00=$25.00 back from the other wagerers. However if the first wagerer loses, he loses his $5.00 initial bet plus another $20.00 as well because he has pay the other wagerers.

Pool bets represent a more limited risk, limited return type wager. In a pool bet, the amount of loss is limited to the size of the wagerer's initial wager amount, so there is no risk of unexpected losses. The amount of winnings is determined by the total size of the pool divided by the number of other wagerers that bet correctly on the outcome. Consider for example, a pool bet situation, where nine wagerers are each betting $5.00. In this example, if four wagerers end up on the losing side, and five wagerers end up on the winning side, then each of the four losing wagerers loses their $5.00 each for a total loss of $20. The five winners each receive their own $5.00 bet back, and additionally receive a one fifth share of the other side's cumulative $20.00 (e.g. $4.00 for each winning wagerer), for a total of each $9.00 back.

In some embodiments, in addition to users initiating pool bets, the house (i.e. the Betville system operators) may also initiate pool bets.

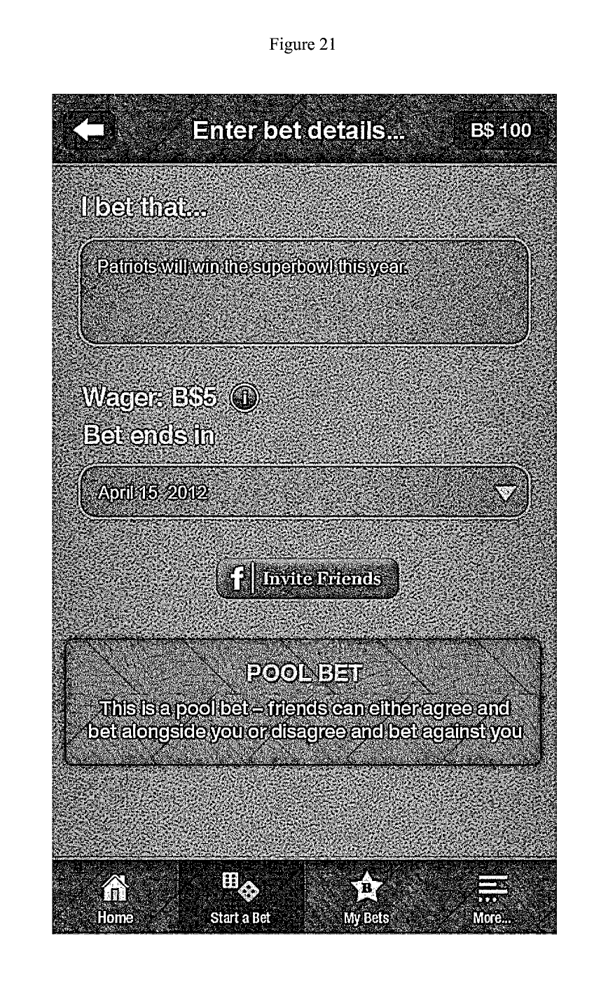

FIG. 21 shows a Betville screen that prompts the user, after starting either a simple or a pool bet add more details to better describe the bet. Here text describing what the bet actually is, along with the size of the wager (in this example kept to a default value of $5.00 in virtual B$5 currency). The user is also prompted to specify the date that the bet will end. In this example, the screen is further reminding the user that this is a pool bet.

Once the details of the bet have been entered, the user can then invite friends to participate, preferably by selecting the friends from a pre-existing social network such as Facebook, Twitter, Google+, and the like.

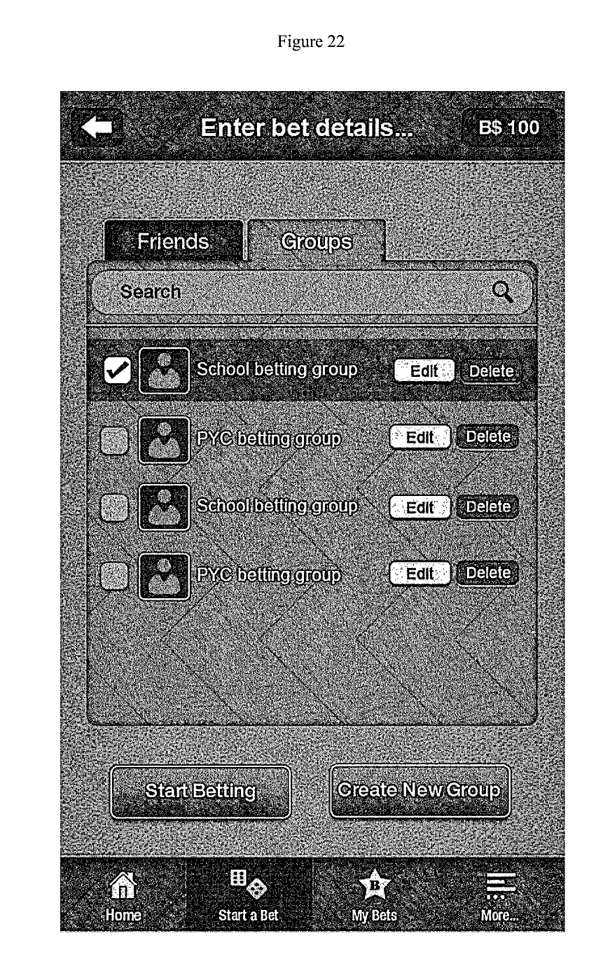

FIG. 22 shows the Betville “Invite friends” page. Here friends may either be individually invited on per-person basis, or alternatively groups of friends may be invited. The Betville app allows the user to create and edit groups of friends, each designated with an appropriate name, to facilitate the betting process. Thus for example the user may create a first group of friends interested in football, and a second group of friends interested in politics, and so on.

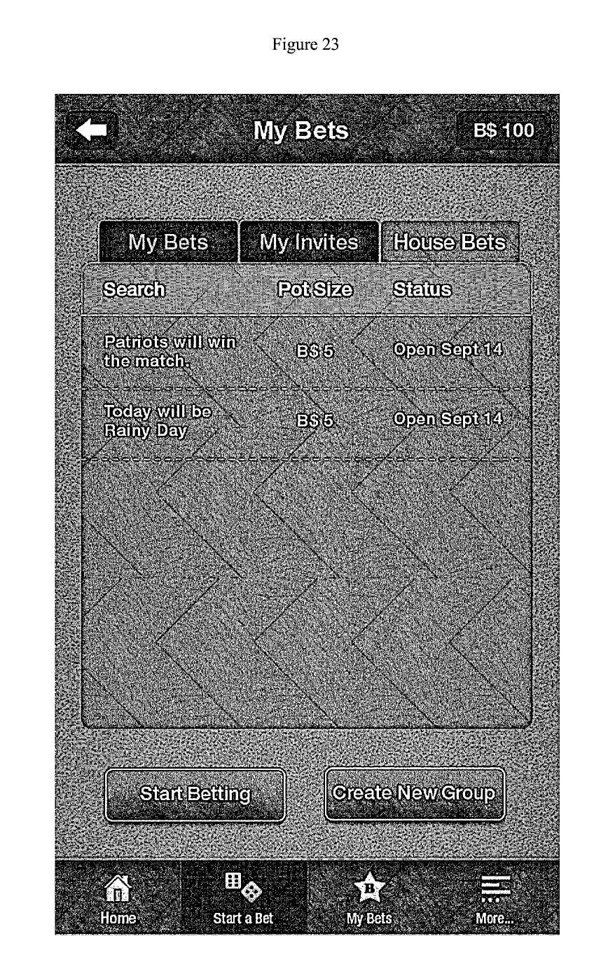

Typically users will initiate multiple wagers, or be invited to multiple wagers. To allow the user to keep track of these wagers, the system provides a “My Bets” screen to allow the status of these wagers to be reviewed. This screen is shown in FIG. 23.

FIG. 23 shows how a user can use the Betville “My Bets” screen to review his current set of wagers. This screen is divided into different tabs. One tab shows the wagers that the user has created, while another tab shows the wagers initiated by others where the user has been invited to participate. A third tab shows the “house bets” which are wagers, generally pool bets, which have been initiated by the Betville system operators.

Once the event that is being wagered upon has passed, the system then needs to settle the wagers in a way that avoids disputes among users. To do this, the various Betville users are asked to agree on the outcome of their various wagers. Once this is done, the Betville system server can then keep track of the book keeping details.

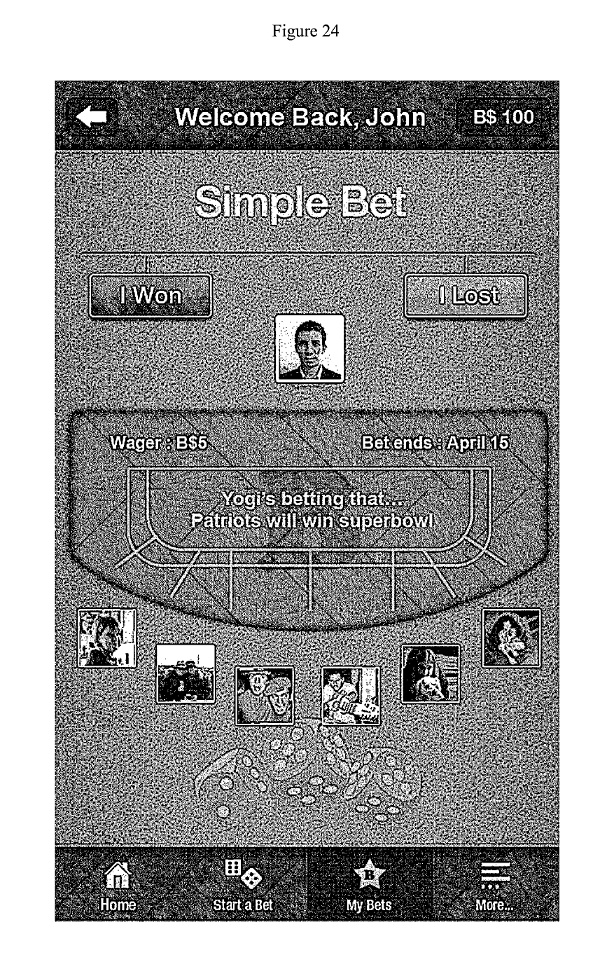

FIG. 24 shows how a user can settle a simple bet. This simple bet is graphically represented by the asymmetric Casino table, showing the user's wager on one side versus the user's friends who have taken the opposite side of the wager. In this screen, the user can asked to confirm that he (or she) indeed won or lost the bet.

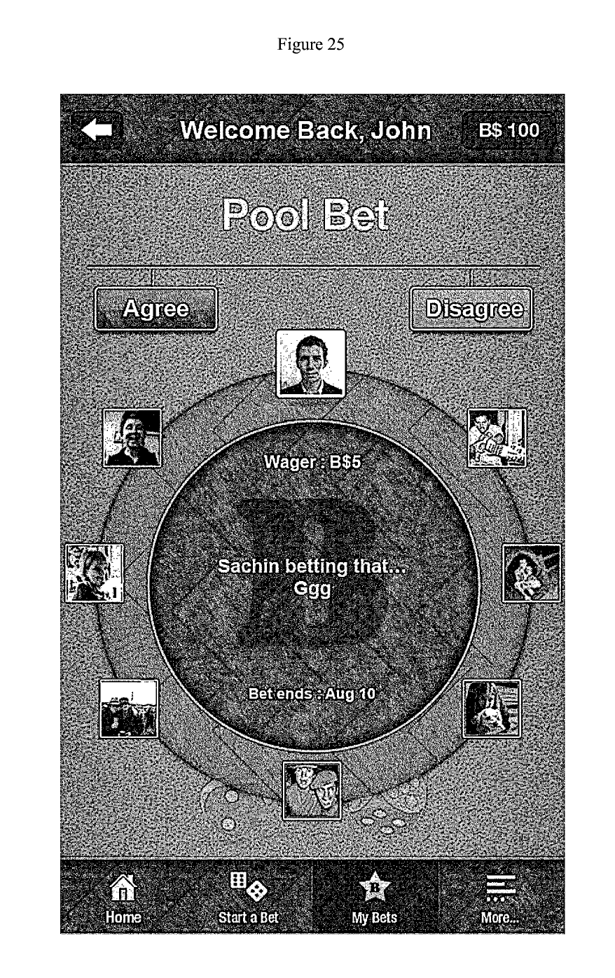

FIG. 25 shows how a user can settle a pool bet. In contrast to a simple, bet, where an asymmetric betting table was shown to remind the user of the asymmetric nature of the simple bet, in a pool bet, a symmetric round table is shown to remind the user that all bettors are sharing risks equally. As before, the user is asked to confirm that he indeed won or lost that particular bet.

In addition to the main betting screens, there are usually various miscellaneous app functions as well that need to be done. In Betville, these are handled by the “More . . . ” screen.

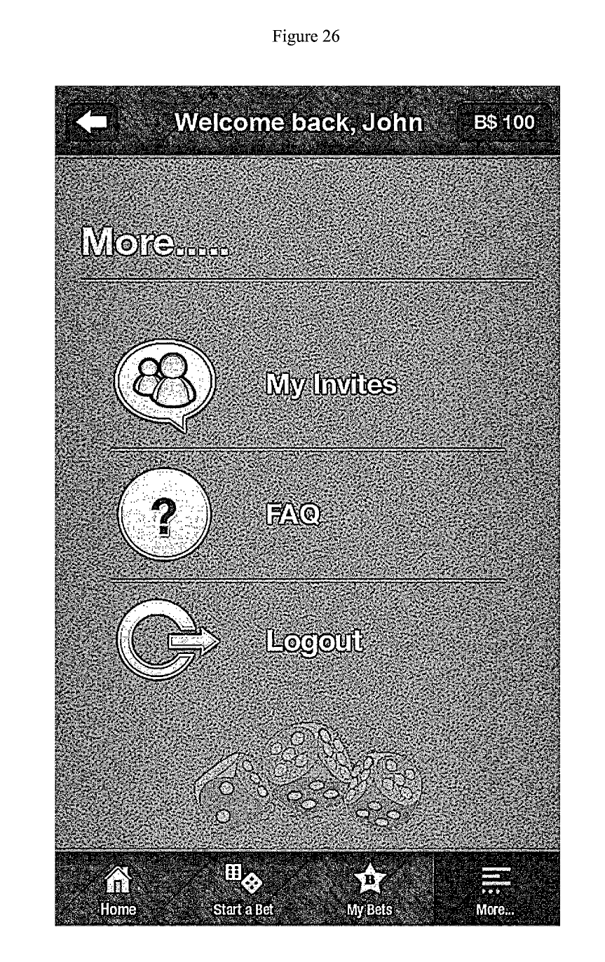

FIG. 26 shows the Betville “More” screen. This screen allows the user to interact with other aspects of the system such review his invites, receive more information about the app, or logout from the app. The “More” screen can also have additional options as well, such as allowing the user to check his virtual currency balance, or purchase additional virtual currency.

To facilitate virtual currency packages, often the user will be shown a screen that will allow the user to purchase various amounts or “packages” of virtual currency, and pay for the virtual currency, generally using various electronic funds transfer methods.

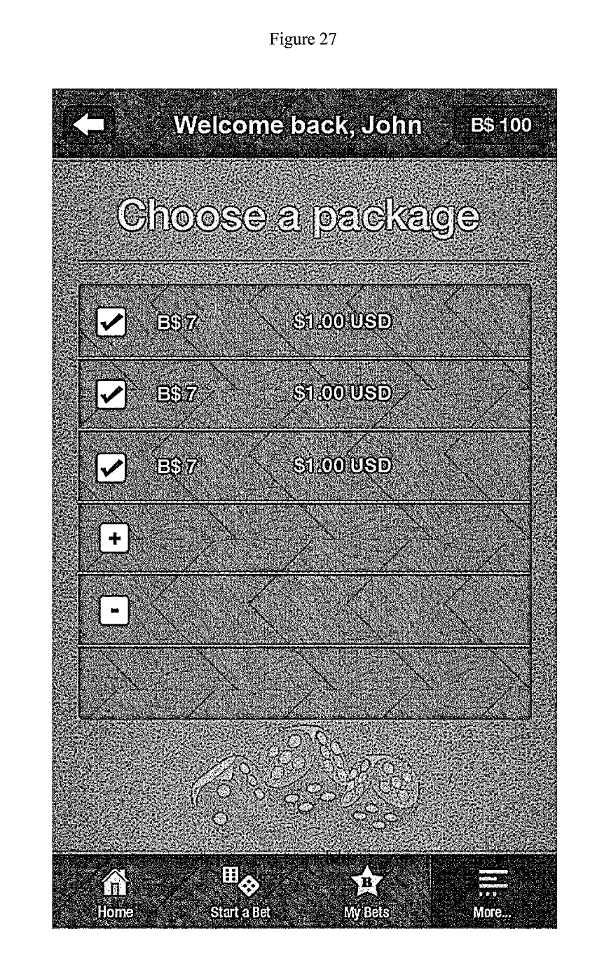

FIG. 27 shows how the user can use a “Betville” “Choose a package” screen to purchase various amounts of virtual currency. To pay for the purchase, the Betville app can be tied into the user's iOS or Android financial accounts. Other payment methods that may be used include PayPal, credit cards, other financial services, and the like.

1. A software implemented computer social network and virtual currency based method of wagering, said method comprising:
at least one wagering network server comprising at least one processor, memory and wagering server software;
a plurality of network connected computerized devices, each said computerized device comprising at least one processor, memory, and a graphical user interface;
wherein an initiating wagerer user uses at least one of said computerized devices to establish at least one wager;
said wager comprising a wager topic regarding the outcome of an unsettled matter, wager terms, a wager end date, and a list of individuals or groups invited to participate in said wager;
said wager terms being either a bet of a specific amount of virtual currency, or odds of return of a return amount of virtual currency in response to a bet amount of virtual currency;
wherein at least some of said individuals or groups are drawn from at least one of said initiating wagerer's computerized social networks; Wherein at least one receiving wageree user receives said at least one wager using at least one computerized device, and uses said graphical user interface to accept said wager;
wherein when said wager end date is reached, said initiating wagerer user, a designated trusted party, or said wagering network server determines the winner or winners of said wager, and redistributes the bet of a specific amount of virtual currency, or odds of return of a return amount of virtual currency in response to a bet amount of virtual currency into virtual currency accounts assigned to said initiating wagerer and said at least one receiving wageree.

2. The method of claim 1, wherein at least some of said network connected computerized devices are either Smartphones, tablet computers, laptop computers, or desktop computers.

3. The method of claim 2, wherein at least some of the steps in said wager are performed using a wagering applications software running on said Smartphone's.

4. The method of claim 1, wherein at least some of said network connected computerized devices are connected to at least one social network with a social network user interface, and wherein at least some of said steps in said wager are performed using said social network user interface.

5. The method of claim 1, wherein when said initiating wagerer user establishes at least one wager, said list of individuals or groups invited to participate in said wager are enabled by said wagering network server to exchange messages with each other and said initiating wagerer user;
and said messages are displayed on the graphical user interfaces of said computerized devices along with information pertaining to said at least one wager.

6. The method of claim 1, wherein said wagering network server additionally keeps track of the status of a virtual currency account assigned to said initiating wagerer user, and blocks entry of wagers where the virtual currency liability of said wager exceeds the virtual currency in said virtual currency account assigned to said initiating wagerer user.

7. The method of claim 1, wherein either the initiating wagerer users or the receiving wageree users may purchase additional virtual currency for their virtual currency accounts, on wherein said initiating wagerer users or receiving wageree users are assigned additional virtual currency for said virtual currency accounts according to the previous experience of said initiating wagerer user or receiving wageree user on said wagering network server.

8. The method of claim 1, further using said computerized device to interrogate said wagering network server regarding the status of some or all wagers initiated by said user, some or all wagers accepted by said user, some or all wagers rejected by said user, some or all wagers which have expired, and some or all wagers which are now closed to further bidding.

9. The method of claim 1, wherein users who are not on any social network can also participate by downloading the application on their computers/Smartphones/tablets and creating a unique user account.

10. The method of claim 1, further offering customized odds on wagering outcomes.

11. The method of claim 1, further importing wagering odds from outside websites or betting organizations.

12. The method of claim 11, wherein said imported wagering odds can be further customized or altered by the user.

13. The method of claim 1, wherein at least one of said users interacts with said wagering network server by way of a third-party social network user interface, so that said wagering appears to be taking place within the context of said third-party computer social network.

14. The method of claim 13, wherein said third-party social network is Facebook, Twitter, or Google+.
